(19) United States
(12) Patent Application Publication
(10) Pub. No.: US 2010/0163745 A1
(43) Pub. Date: Jul. 1, 2010

(54) Housing for A Micro-Column

(75) Inventors: Ho Seob Kim, Chonan-si (KR); Byeng Jin Kim, Incheon (KR)

Correspondence Address: PARK LAW FIRM, 3255 WILSHIRE BLVD, SUITE 1110, LOS ANGELES, CA, 90010, US

(73) Assignee: CEBT CO. LTD., Chungeheongnam-do (KR)

(21) Appl. No.: 11/817,069

(22) PCT Filed: Feb. 23, 2006
(86) PCT No.: PCT/KR2006/000627

§ 371 Date: Sep. 4, 2007

(30) Foreign Application Priority Data
Feb. 24, 2005 (KR) 10-2005-0015605

(51) Int. Cl. H01J 3/26; G21K 1/00

(52) U.S. Cl. 250/396 R

(57) ABSTRACT

Disclosed therein is a housing for micro-column, which can easily align and assemble the micro-column and improve stability of the micro-column. The housing for manufacturing micro-column including an electron emitter, deflectors, and lenses, the housing includes: an electron emitter holder in which the electron emitter is inserted; a holder base in which the electron emitter holder is inserted; and a column base coupled with the holder base, whereby the electron emitter can be aligned and fixed between the electron emitter holder and the holder base in X- and Y-axial directions via bolts and socket set screws inserted into the tap holes.

### TECHNICAL FIELD

The present invention relates to a housing for use in a micro-column including an electron emitter and a lens, and more particularly, to a housing for a micro-column, which can allow for easier alignment and assembly of electron emitter and lenses.

### BACKGROUND ART

An electron emitter operated under the fundamental principle of a scanning tunneling microscope (STM) and a micro-column based on electron-optic components of fine structures have been first introduced in 1980's. The micro-column forms an improved electron column by minimizing optical abberations by delicately assembling with fine components, and a small structure can be used in a multi-column structure of a parallel structure or a series structure by arranging a plurality of small structures.

Such micro-column is a precisely fabricated structure with micro-lenses and deflectors. Such micro-column generally includes an electron emitter, a source lens, deflectors, and an Einzel lens.

In the micro-column, alignment and fixation of the electron emitter, the source lens and the Einzel lens is very important in relation with performance of the micro-column. In relation with the alignment and fixation of such micro-column, a conventional micro-column is disclosed in “Experimental evacuation of a 20×20 mm footprint microcolumn” on pp. 3792 and 3796 of Journal of Vacuum & Science Technology B14(6) published in 1996.

FIG. 1 is a perspective view of the conventional micro-column. The micro-column 10 includes an electron emitter, a source lens, deflectors, and an Einzel lens aligned and fixed therein. An upper plate 2 supports the electron emitter together with a micro-positioner (not shown) located thereon, and has a through-hole formed at the center thereof for positioning the electron emitter 1. The upper plate 2 and a lower plate 5 for receiving the lens are connected with each other through four supporting bars 6 via bolts. The source lens 3 is fixed on the upper portion of the lower plate 5 by epoxy bonding in a state where the source lens 3 and the electron emitter 1 are aligned in their position. Deflectors 4 are arranged at right and left of the lower plate 5. Furthermore, the Einzel lens (not shown) is aligned and fixed below the lower plate 5 in the same way as the source lens and oppositely to the source lens 3. The upper plate and the lower plate 2 and 5 respectively have through-holes formed at the central axes thereof for allowing penetration of electron beam emitted from the electron emitter 1 through the lenses and the deflectors.

Such conventional micro-column needs the micro-positioner for aligning and fixing the electron emitter and the source lens. Moreover, if there is any error in the lens, it is difficult to replace the lens with a new one. Additionally, in such conventional micro-column, shield is not formed well in relation with wiring of the lenses and the deflectors, and so, it may causes malfunction of the micro-column and electromagnetic noise. The conventional micro-column is expensive, and needs lots of time and efforts to align and fix the electron emitter and lenses. In addition, the entire micro-column cannot be used once one of the lenses is out of order.

### DISCLOSURE OF INVENTION

### Technical Problem

Accordingly, the present invention has been made to solve the above-mentioned problems occurring in the prior art, and it is an object of the present invention to provide a housing for micro-column, which can easily align and fix an electron emitter and lenses, and which can easily replace each of components with a new one, and form a shield well.

### Technical Solution

To accomplish the above object, according to the present invention, there is provided a housing for use in a micro-column including an electron emitter, deflectors, and lenses, comprising:

an electron emitter holder in which the electron emitter is inserted;

a holder base in which the electron emitter holder is inserted; and

a column base coupled with the holder base, wherein the electron emitter holder, the holder base, and the column base are separately assembled.

Furthermore, according to the present invention, the lens is inserted into a lens plate, and the lens plate is detachably connected with other component so that the lens is not in a direct contact with other component.

Moreover, a housing for use in a micro-column including an electron emitter, deflectors, and lenses, comprises:

an electron emitter holder having a hollow portion for inserting the electron emitter thereinto;

a holder base in which the electron emitter holder is inserted coaxially, the first lens part of the lenses being connected on the bottom surface of the holder base;

a lens plate in which the second lens part is inserted and fixed, the lens plate having a hollow hole; and

a hollow column base coupled with the holder base at the upper portion thereof, the column base having through-holes radially formed at the center thereof for inserting deflectors thereto, and a stepped part formed on the inner periphery thereof for inserting the lens thereto,

wherein the electron emitter is aligned and fixed inside the electron emitter holder in X-, Y-, and Z-axial directions.

### Advantageous Effects

The housing for the micro-column according to the present invention does not need an expensive micro-positioner and a member for adjusting position of the electron emitter, and so, is simple in structure.

The housing for the micro-column according to the present invention can rapidly and easily replace a defected component with a new one when the component such as the electron emitter or the lens is out of order, thereby easily repairing or reusing the expensive micro-column.

The housing for the micro-column according to the present invention arranges all wires inside the housing, thereby optimizing the performance of the micro-column by an effect of shielding wires from electromagnetic fields and other signals and an effect for safely protecting the wires.

While the present invention has been described with reference to the particular illustrative embodiments, it is not to be restricted by the embodiments, and it is to be appreciated that those skilled in the art can change or modify the embodiments without departing from the scope and spirit of the present invention.

### BRIEF DESCRIPTION OF THE DRAWINGS

FIG. 1 is a perspective view of a conventional micro-column.

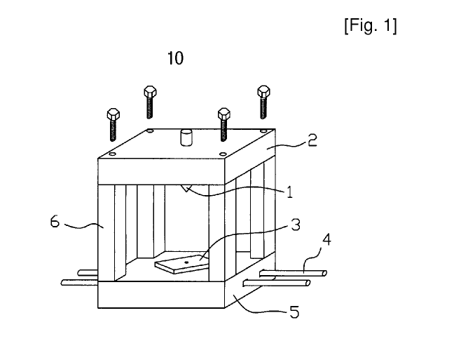

FIG. 2 is an exploded perspective view of a housing for a micro-column according to a preferred embodiment of the present invention.

FIG. 3 is an exploded perspective view of a housing for a micro-column according to another preferred embodiment of the present invention.

### MODE FOR THE INVENTION

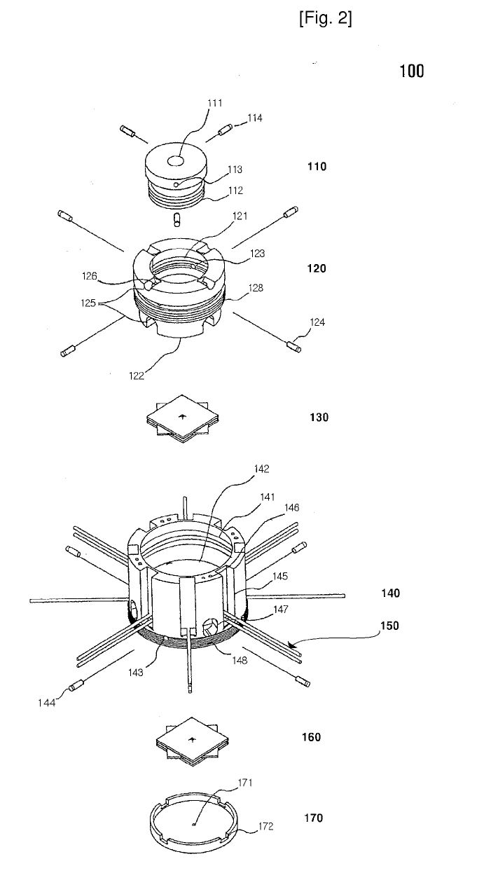

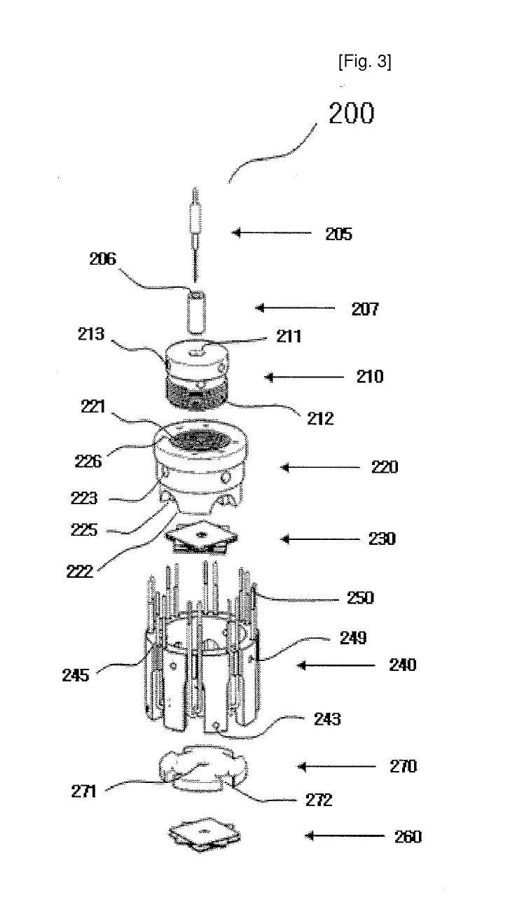

Hereinafter, referring to FIGS. 2 and 3, a structure of a micro-column manufacturing using a housing according to the present invention will be described in detail.

FIG. 2 shows the structure of the micro-column 100 manufactured using the housing according to the first preferred embodiment of the present invention. In FIG. 2, the micro-column includes an electron emitter, a source lens, deflectors, and an Einzel lens as a focus lens.

The housing according to the present invention includes an electron emitter holder 110, a holder base 120, and a column base 140. Hereinafter, referring to the drawings, the present invention will be described in more detail.

The electron emitter holder 110 includes a through-hole 111 formed at the center thereof for inserting the electron emitter (not shown) thereinto, and the electron emitter inserted into the through-hole 111 is fixed by fastening bolts or socket set screws 114 through tap holes 113 radially formed from a central axis. X-axis, Y-axis and Z-axis of the electron emitter can be adjusted, aligned and fixed by the socket set screws 114. However, according to circumstances, the electron emitter can be bonded. The electron emitter holder 110 further includes a screw thread 112 formed on the lower portion thereof, and so, is coaxially screwed with the holder base 120. The screw thread 112 can be formed on the lower portion of the electron emitter holder 110 as shown in the drawing, but can be formed on the entire outer periphery of the electron emitter holder 110 in order to widen a coaxially screwed range. The remaining area of electron emitter holder 110 excepting the area of the electron emitter holder 110 where the screw thread 112 and the through-hole 111 are formed may have a round or a polygonal outward appearance.

The holder base 120 is in a hollow cylinder form, and includes a screw thread 121 corresponding to the screw thread 112 of the electron emitter holder 110 so as to be coaxially screwed with the electron emitter holder 110. Moreover, a source lens 130 is connected to a bottom surface 122 of the holder base 120 through a direct bonding. Four tap holes 123 are radially formed in the holder base 120 from the central axis of the holder base 120 in a rectangular direction, so as to be more firmly coupled with the electron emitter holder 110 via bolts or socket set screws 124. The number of the tap holes 123 and the socket set screws 124 can be set as occasion demands, but it is preferable that three or more tap holes 123 and socket set screws 124 are formed for alignment. The electron emitter holder 110 in which the electron emitter is inserted and the holder base 120 to which the source lens 130 is connected by bonding are screwed with each other. At this time, the X-axes and the Y-axes of the electron emitter and the source lens 130 are aligned by the socket set screws 114 and 124 through the tap holes 113 and 123, and the Z-axes thereof can be aligned by adjusting a height formed when the electron emitter holder 110 and the holder base 120 are screwed. Therefore, the electron emitter and the source lens 130 can be easily aligned and fixed. It is not indispensible that the socket set screws are used for the alignment and fixation, and additional fixing means are not needed if the screw-coupling can secure a firm fixation, and other means such as wedges or dowel pins can be inserted into the tap holes. Refuging portions 125 formed on the upper portion and the lower portion of the holder base 120 are for wiring of the source lens 130, namely, wires of the source lens 130 can extend upwardly through vertically through-holes 126 formed inside the refusing portions 125. The wires of the source lens 130 can go upwardly in a vertical direction if a diameter (diagonal) distance between the through-holes 126 is larger on the coaxial line than the outer diameter of the electron emitter holder 110. A screw thread 128 formed on the outer periphery of the holder base 120 is to be screwed with the column base 140 located below the holder base 120.

The column base 140 is in a hollow cylindrical form, and includes a stepped part 142 formed on the inner periphery of the lower part thereof, and the stepped part 142 has a through-hole (not shown) formed on the central axis thereof for passing electron beam emitted from the electron emitter. The column base 140 includes a screw thread 141 formed on the inner periphery of the upper part thereof to be screwed with the screw thread 128 of the holder base 120, and a plurality of through-holes radially formed from the central axis. Deflectors 150 are inserted into the through-holes. An Einzel lens 160 is coupled with a lens plate 170 by bonding, and then inserted into the lower portion of the stepped part 142 of the column base 140. Therefore, a vertical position of the Einzel lens 160 can be decided according to a position of the stepped part 142. For connection between the lens plate 170 and the column base 140, tap holes 143 are radially formed on the lower portion of the column base 140 from the central axis. Therefore, the Einzel lens 160 and the lens plate 170 are aligned and fixed by bolts and socket set screws 144 when they are bonded and inserted into the column base 140. The Einzel lens 160 and the lens plate 170 can be finally aligned and fixed on a micro-column 100, or aligned and fixed on the micro-column 100 after being previously coupled with the column base 140 via the socket set screws. The column base 140 has wire refusing portions 145 formed on the outer periphery thereof for wiring of the deflectors 150, whereby wires of the deflectors 150 can be bended vertically and extend upwardly or downwardly. That is, the wires of the deflectors 150 can easily extend upwardly or downwardly if a diameter (diagonal) distance between the refusing portions 145 is larger than the outer diameter of the holder base 120. For wiring of the Einzel lens 160, the column base 140 has vertical holes 146 vertically formed therein and communicating with through-holes 147 radially formed at the lower end portion thereof.

The lens plate 170 includes a hole 171 formed at the center thereof for passing electron beam therethrough, and refusing grooves 172 formed on the rim thereof for wiring of the Einzel lens 160. The Einsel lens 160 is inserted into and bonded to the lens plate 170.

The wires of the Einzel lens 160 passes through the refusing holes 172, enter into the through-holes 147 of the column base, and then, extend upwardly through the vertical holes 146. Therefore, in the micro-column according to the present invention, all wires of the source lens, the deflectors, and the Einzel lens extend upwardly along the outer wall of the housing, and so, the housing for the micro-column can provide shielding effect to the electromagnetic field according to materials of the housing, and easily align and safely protect the wires thereof.

A screw thread 148 formed on the lower end of the outer periphery of the column base 140 is to be coupled with other components, such as a sample or the detector, and so, formed to easily utilize the micro-column. The screw thread 148 is formed on the outer periphery of the column base 140 in the drawing, but can be formed on the inner periphery or on the inner and outer peripheries.

FIG. 3 shows a configuration of a micro-column 200 manufactured by using a housing according to another preferred embodiment of the present invention. The micro-column 200 shown in FIG. 3 also includes an electron emitter, a source lens, deflectors, and an Einzel lens as a focus lens.

The housing according to this embodiment also includes an electron emitter holder 210, a holder base 220, and a column base 240. Hereinafter, referring to the drawing, this embodiment will be described in more detail.

In this embodiment shown in FIG. 3, the electron emitter holder 210, the holder base 220, the source lens 230, the column base 240, an Einzel lens 260, and a lens plate 270 are equal or similar in structures and functions with those of the first embodiment shown in FIG. 2, and so, hereinafter, differences between the first embodiment and the second embodiment will be mainly described.

The electron emitter 205 is inserted into a cap 206, and then inserted into a through-hole 211 formed at the center of the electron emitter holder 210. After that, the electron emitter 205 is fixed through tap holes 213 radially formed from the central axis via bolts or socket set screws. The electron emitter holder 210 of this embodiment has a screw thread 212 formed in the same way as the electron emitter holder 110 of FIG. 2 or in a similar way to the electron emitter holder 110.

Similarly with the holder base 120 shown in FIG. 2, the holder base 220 of this embodiment includes a screw thread 221 coupled with the screw thread of the electron emitter holder 210, a bottom surface 222 connected with the source lens 230 illustrated below the holder base 220, a plurality of tap holes 223 radially formed therein from the central axis, and refusing portions 225 and through-holes 226 vertically formed on the lower portion thereof for wiring of the source lens 130. The electron emitter holder 210 in which the electron emitter is inserted and the holder base 220 to which the source lens 230 is connected by bonding are screwed with each other. At this time, X-axes, Y-axes and Z-axes of the electron emitter and the source lens 230 are mainly aligned by the socket set screws 214 and 224 through the tap holes 213 and 223, and the Z-axes thereof can be also aligned by adjusting a height formed when the electron emitter holder 210 and the holder base 220 are screwed. The holder base 220 has no screw thread on the outer periphery thereof, differently from the holder base 120 which has the screw thread 128 formed on the outer periphery thereof as shown in FIG. 2.

Similarly with the column base 140 of FIG. 2, the column base 240 is in the form of a hollow cylinder, and includes a plurality of tap holes 249 for fixing the holder base 220 which is inserted into the column base 240. The deflectors 250 are inserted into the column base 240 through a plurality of through-holes radially formed from the central axis of the column base 240. The column base 240 has a plurality of tap holes 243 radially formed on the lower portion thereof from the central axis, so that the Einzel lens 260 which is coupled with the lens plate 270 by bonding is inserted into the column base 240 and aligned and fixed to the column base 240 via bolts or socket set screws inserted into the tap holes 243. Furthermore, like the steppe part 142 of FIG. 2, the column base 240 has a stepped part, a vertical position of the Einzel lens 260 is decided by the position of the stepped part. The column base 240 has a plurality of refusing portions 245 formed on the outer periphery thereof for wiring of the deflectors 250 and the Einzel lens 260, whereby wires of the deflectors 250 can be bended vertically and extend upwardly or downwardly. That is, the wires of the deflectors 250 and the Einzel lens 260 can easily extend upwardly or downwardly if a diameter (diagonal) distance between the refusing portions 245 is larger than the outer diameter of the holder base 220.

The lens plate 270 includes a hole 271 formed at the center thereof for passing electron beam therethrough, and refusing grooves 272 formed on the rim thereof for wiring of the Einzel lens 260. The Einzel lens 260 is inserted into bonded to the lens plate 270.

The wires of the Einzel lens 260 passes through the refusing holes 272, and extend upwardly through the refusing portions 245 of the column base 240. Therefore, in the micro-column using the housing according to the present invention, all wires of the source lens, the deflectors and the Einzel lens extend upwardly along the outer wall of the housing, and so, the micro-column can provide shielding effect to the electromagnetic field according to materials of the column, and easily align and safely protect the wires thereof.

Differently from FIG. 2, in this embodiment, the holder base 220 and the column base 240 are not screwed with each other, and in the same way, the electron emitter holder 210 and the holder base 220 can be coupled with each other using the tap holes 213 without screwing each other. That is, screwing is not essential in the housing according to the present invention. Furthermore, the lens plate 270 and the Einzel lens 260 are coupled with each other on the contrary to the coupling method of the first embodiment shown in FIG. 2. Also, in the first embodiment shown in FIG. 2, such coupling between the lens plate 270 and the Einzel lens 260 forms a surface contact with the stepped part 142 so as to achieve a more firm connection.

In the micro-columns 100 and 200 shown in FIGS. 2 and 3, the source lens is connected to the lower end of the holder base by direct bonding, but can be connected using the lens plate in the same way as the connection between the Einzel lens and the column base.

The holder base and the column base are connected with each other by a direct screwing in FIG. 2, and connected with each other by using the tap holes in FIG. 3, but may be connected with each other using additional fixtures or bolts in the same way as the prior arts.

The electron emitter holder, the holder base and the column base are in the cylinder form in the drawings, but may be in a polygonal form.

The configuration of the micro-column assembled by using the housing according to the present invention is divided into a connection structure between the electron emitter holder and the holder base for fixing the position of the electron emitter, a structure for easily aligning, assembling and replacing lenses using the lenses and the lens plate, and a structure between the holder base and the column base for an easy wiring of the column.

In the micro-column assembled using the housing according to the present invention, if there is any error in the electron emitter, only the electron emitter holder is rapidly replaced with a new one, and the new electron emitter holder is aligned and fixed to the source lens connected to the holder base. Moreover, if there is any error in the source lens, only the holder base is rapidly replaced with a new one, or the lens plate for the source lens is replaced. If there is any error in the Einzel lens, only the Einzel lens and the lens plate are rapidly replaced and aligned. So, the housing for the micro-column according to the present invention is very useful in alignment and repair of the components.

The housing for the micro-column according to the present invention described above is an example for the most preferable micro-column, and rapidly and easily achieve alignment and fixation of the electron emitter, alignment and fixation of the electron emitter and the lenses, and alignment and connection of the lenses, and so, easily achieve alignment and connection of the entire column.

That is, the lenses used in the micro-column using the housing according to the present invention are the source lens and the focus lens, but general electronic lenses or other things having the electronic lens form can be used. The wire type deflectors are not essential in this invention. Moreover, the electronic lenses can be fixed using the stepped part 142 of the first embodiment of FIG. 2. If the position and thickness of the stepped part on the X-axis is previously defined, lenses can be respectively or selectively connected on the upper surface and the lower surface of the stepped part by the direct bonding without the lens plate. Alternatively, the lens can be connected on the upper surface or the lower surface of the stepped part using the lens plate. That is, the electronic lenses or the same things can be aligned and connected on the column base using the stepped part.

According to the spirit and the scope of the present invention, not only the column using the source lens and the Einzel lens but also the column using the electron emitter and the lenses can easily achieve alignment and connection.

### INDUSTRIAL APPLICABILITY

The housing for the micro-column according to the present invention is used for manufacturing micro-columns. The micro-column can be used in various fields such as lithography, electronic endoscope, display, and so on, and the housing according to the present invention can more easily align and assembly the micro-column, and improve stability of the micro-column.

1. A housing for use in a micro-column including an electron emitter, deflectors, and lenses, the housing comprising: an electron emitter holder in which the electron emitter is inserted; a holder base in which the electron emitter holder is inserted; and a column base coupled with the holder base, wherein the electron emitter holder, the holder base and the column base are separately assembled.

2. The housing for micro-column according to claim 1, wherein the lens is inserted into a lens plate, and the lens plate is detachably connected with other component so that the lens is not in a direct contact with other component.

3. The housing for micro-column according to claim 1, wherein the electron emitter holder includes a hollow portion for inserting the electron emitter thereto, wherein the holder base includes the bottom surface for coupling with the lens, and wherein the column base includes through-holes radially formed from the center thereof for inserting deflectors thereto, and a stepped part formed on the inner periphery thereof for inserting the lens thereto.

4. The housing for micro-column according to claim 1, wherein the electron emitter holder and the holder base respectively further comprise screw threads which correspond to each other or the holder base has a plurality of tap holes formed radially, whereby the electron emitter holder can be aligned inside the holder base in X-, Y- and Z-axial directions.

5. The housing for micro-column according to claim 2, wherein the lens plate and the holder base respectively have holes or grooves radially formed for wires of the lens, and the column base includes refusing grooves or holes vertically formed for wires of the lens and the deflectors.

6. The housing for micro-column according to claim 1, wherein the holder base includes a plurality of tap holes radially formed thereon, whereby the electron emitter can be aligned and fixed between the electron emitter holder and the holder base in X- and Y-axial directions via bolts and socket set screws inserted into the tap holes.
